(19) United States
(12) Patent Application Publication
(10) Pub. No.: US 2026/0322224 A1
(43) Pub. Date: Oct. 15, 2026

(54) Cutting Apparatus For Wire Hairpin Ends

(71) Applicant: Comau (Shanghai) Engineering Co., Ltd., Shanghai (CN)

(72) Inventors: Yunhui Gao, Shanghai (CN); Lei Suo, Shanghai (CN)

(21) Appl. No.: 19/486,134

(22) PCT Filed: May 16, 2024
(86) PCT No.: PCT/CN2024/093705

§ 371 Date: Nov. 20, 2025

(30) Foreign Application Priority Data
May 22, 2023 (CN) 202310579635.0

(51) Int. Cl. H02K 15/0643; B23D 33/02; B23D 35/00; B23Q 11/00

(52) U.S. Cl. CPC H02K 15/0643; B23D 33/02; B23D 35/002; B23Q 11/0053

(57) ABSTRACT

A cutting apparatus for jointly cutting a plurality of wire hairpin ends protruding from an annular housing of a stator to obtain wire square flat ends.

The cutting apparatus includes a cutting device driven by at least one actuator unit.

The cutting device includes a first disc having equidistant spiral grooves, and a second disc having equidistant T-shaped grooves.

Radial cam cutter assemblies carried by the first disc and the second disc, arranged around a central common axis, include a blade directed towards said central common axis, and a linear drive support element.

The at least one actuator unit rotatably drives the first disc causing a simultaneous radial movement of the blades for jointly cutting the wire hairpin ends.

### CROSS-REFERENCE TO RELATED APPLICATION(S)

This application is filed pursuant to 35 U.S.C. § 371 claiming priority benefit to PCT/CN2024/093705 filed May 16, 2024, which claims priority benefit to China Patent Application No. 202310579635.0 filed May 22, 2023, the contents of both applications are incorporated herein by reference in their entirety for all purposes.

### TECHNICAL FIELD

The present invention generally refers to apparatus and methods for the manufacture of electrical machines, and relates in particular to a cutting operation of a plurality of wire hairpin ends protruding from an annular housing of a component for an electrical machine, in particular a stator.

### BACKGROUND

As known, hairpin technology is a winding technology applied in the field of electric motors, based on solid, flat copper bars which are inserted into a stator stack. These copper bars, so called “hairpins”, consist of enameled copper wire bent into a U-shape.

According to a conventional technique, after inserting the hairpins into an annular housing of a component for an electrical machine, such as a stator, it is necessary to perform a cutting operation for cutting a plurality of wire hairpin ends protruding from the annular housing, in order to obtain wire square flat ends protruding from the annular housing.

### SUMMARY

The present invention starts from the desire to provide a cutting apparatus of the type indicated above, improving from various points of view the known solutions.

In order to achieve the above-mentioned object, the present invention is directed to a cutting apparatus for jointly cutting a plurality of wire hairpin ends protruding from an annular housing of a component for an electrical machine, in particular a stator, in order to obtain wire square flat ends protruding from the annular housing,
wherein the cutting apparatus comprises a cutting device driven by at least one actuator unit, said cutting device comprising:
a first disc having a plurality of equidistant spiral grooves, and a second disc having a plurality of equidistant T-shaped grooves, wherein the second disc is axially arranged above the first disc, so that the two discs have a central common axis,
a plurality of radial cam cutter assemblies carried by the two discs and arranged around said central common axis, wherein each cam cutter assembly comprises a blade having a cutting edge directed towards said central common axis, and a linear drive support element which includes a cutter holder, and a cam,
wherein the cams are mounted into the equidistant spiral grooves, and the cutter holders are radially slidably mounted within the T-shaped grooves,
wherein said at least one actuator unit is configured for driving in rotation the first disc, in order to cause a simultaneous radial movement of the blades for jointly cutting wire hairpin ends protruding from the annular housing.

The present invention is also directed to a method for jointly cutting a plurality of wire hairpin ends protruding from an annular housing of a component for an electrical machine, in particular a stator, in order to obtain wire square flat ends protruding from the annular housing, comprising:
providing a cutting device driven by at least one actuator unit, said cutting device comprising:
a first disc having a plurality of equidistant spiral grooves, and a second disc having a plurality of equidistant T-shaped grooves, wherein the second disc is axially arranged above the first disc, so that the two discs have a central common axis,
a plurality of radial cam cutter assemblies carried by the two discs and arranged around said central common axis, wherein each cam cutter assembly comprises a blade having a cutting edge directed towards said central common axis, and a linear drive support element which includes a cutter holder, and a cam,
wherein the cams are mounted into the equidistant spiral grooves, and the cutter holders are radially slidably mounted within the T-shaped grooves,
said method comprising the operation of driving in rotation the first disc, in order to cause a simultaneous radial movement of the blades for jointly cutting wire hairpin ends protruding from the annular housing.

Preferably, each spiral groove is engaged by two cams carried by two adjacent cutter holders, wherein said two adjacent cutter holders have a different length, so that all the cutting edges result equally distanced from the common central axis of the discs.

Preferably, said at least one actuator unit comprises a left oil cylinder structure device and a right oil cylinder structure device respectively connected to two sides of the cutting device.

Preferably, the cutting apparatus comprises a waste funnel arranged below the cutting device, and a waste pipeline connected to the waste funnel, in such a way that, after cutting the wire ends, the cut material may be wasted by gravity through the waste funnel and the waste pipeline.

### BRIEF DESCRIPTION OF THE DRAWINGS

Further characteristics and advantages of the invention will become apparent from the description that follows with reference to the attached drawings, provided purely by way of non-limiting example, wherein:

FIG. 1 is a schematic perspective view of a flat cutting apparatus, according to the present invention;

FIG. 2 is a schematic elevational view of a bottom frame of the flat cutting apparatus, according to the present invention;

FIG. 3 is a schematic perspective view of a cutting device of the flat cutting apparatus, shown in a main working position;

FIG. 4 is a schematic perspective view of a left oil cylinder structure of the flat cutting apparatus;

FIG. 5 is a schematic perspective view of a right oil cylinder structure of the flat cutting apparatus;

FIG. 6 is a schematic perspective view of a cutting device of the flat cutting apparatus;

FIG. 7 is a cross-sectional view of an internal structure of a cam cutter assembly;

FIG. 8 is a schematic cross-sectional view of a part of the cutting device;

FIGS. 9,10 are schematic perspective views showing further features of the cutting device; and

FIG. 11 is a schematic perspective view of a cam cutter assembly.

### DETAILED DESCRIPTION

In the following description various specific details are illustrated aimed at a thorough understanding of examples of one or more embodiments. The embodiments may be implemented without one or more of the specific details, or with other methods, components, materials, etc. In other cases, known structures, materials or operations are not shown or described in detail to avoid obscuring various aspects of the embodiments. The reference to “an embodiment” in the context of this description indicates that a particular configuration, structure or characteristic described in relation to the embodiment is included in at least one embodiment. Therefore, phrases such as “in an embodiment”, possibly present in different places of this description do not necessarily refer to the same embodiment. Moreover, particular conformations, structures or characteristics can be combined in a suitable manner in one or more embodiments and/or associated with the embodiments in a different way from that illustrated here, for example, a characteristic here exemplified in relation to a figure may be applied to one or more embodiments exemplified in a different figure. The references illustrated here are only for convenience and do not therefore delimit the field of protection or the scope of the embodiments.

The present invention relates to a cutting apparatus for jointly cutting a plurality of wire hairpin ends protruding from an annular housing of a component for an electrical machine, in particular a stator, in order to obtain wire square flat ends protruding from the annular housing.

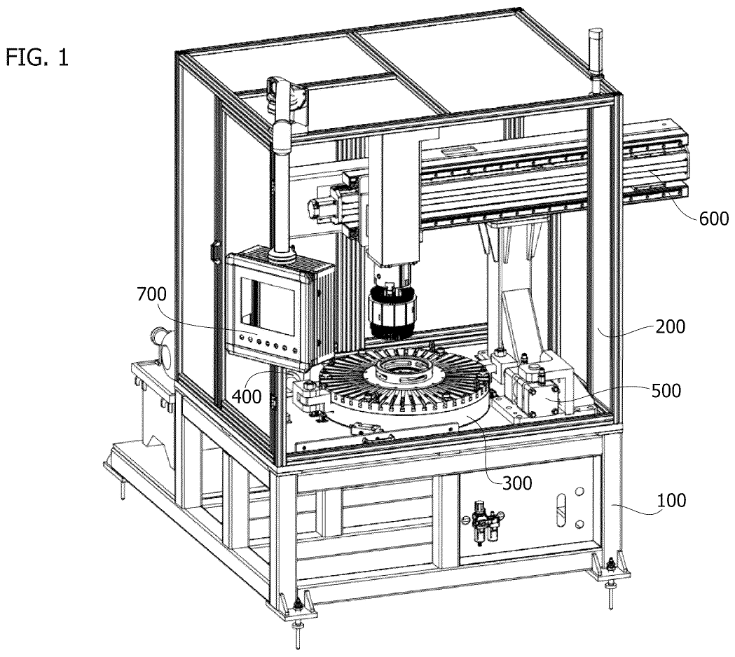

The cutting apparatus of the present invention is configured as a cutting station of a manufacturing line for producing at least one type of component for an electrical machine, such as stators (shown in FIG. 1).

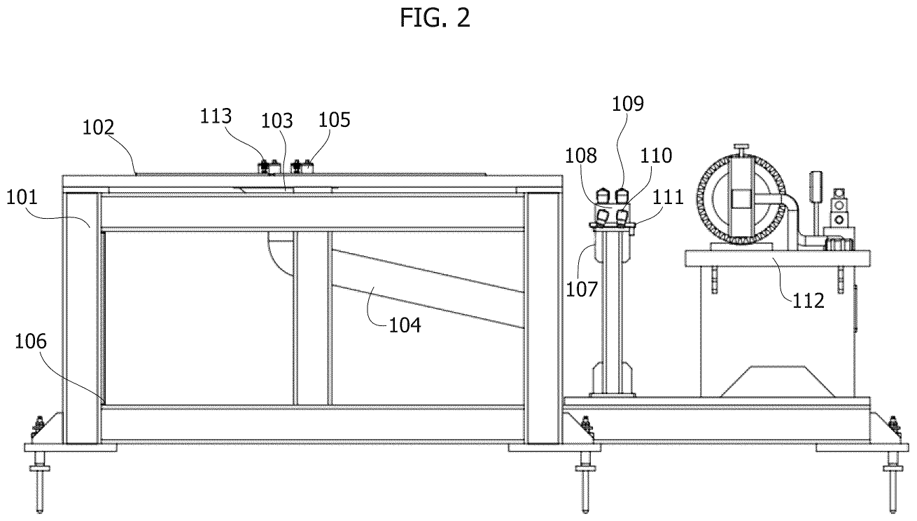

According to FIG. 1, the cutting apparatus of the present invention comprises a base frame assembly 100, a peripheral frame assembly 200 arranged on the base frame assembly 100, a cutting device 300 arranged on the frame assembly 100, at least one actuator unit for actuating the cutting device 300, a robotic manipulator 600, and a HMI interface 700. As shown in FIG. 2, the base frame assembly 100 may include frame supports 101 and a table top plate 102.

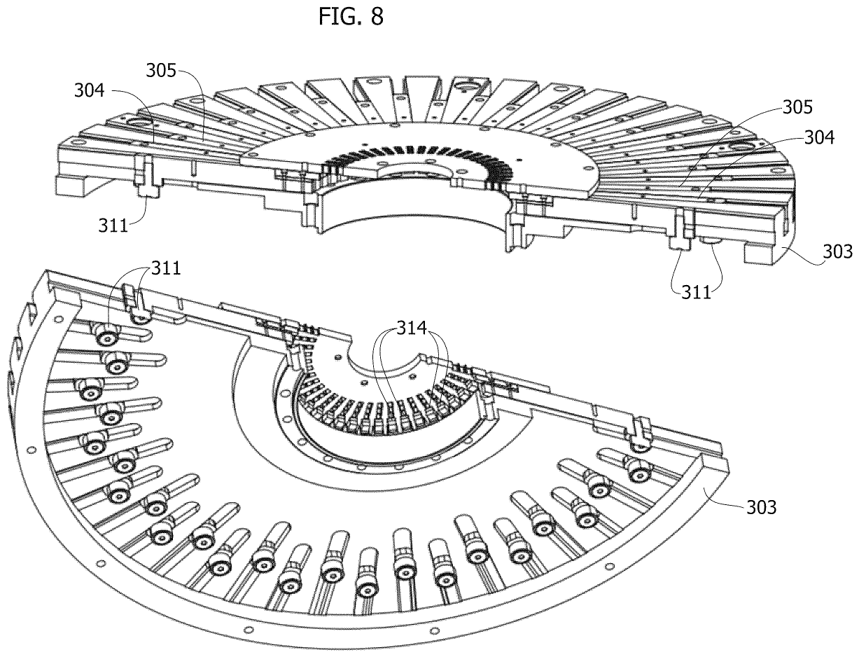

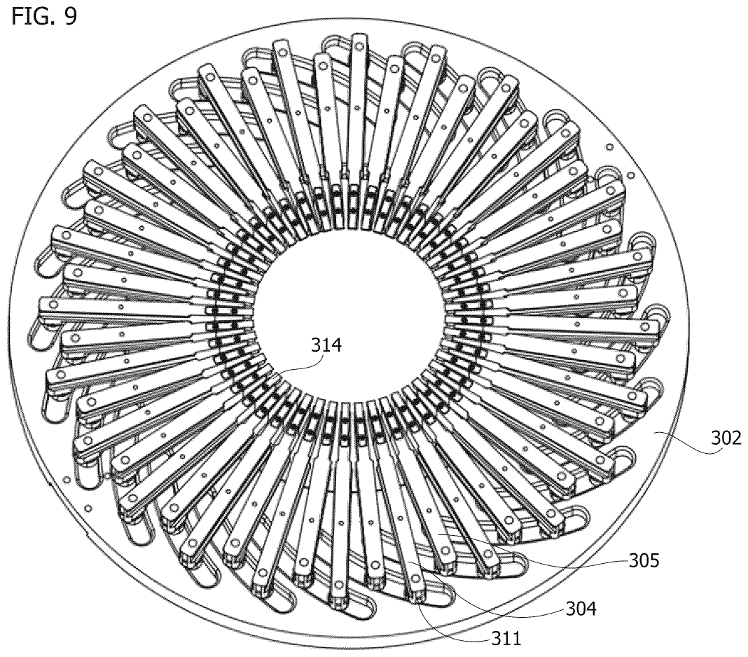

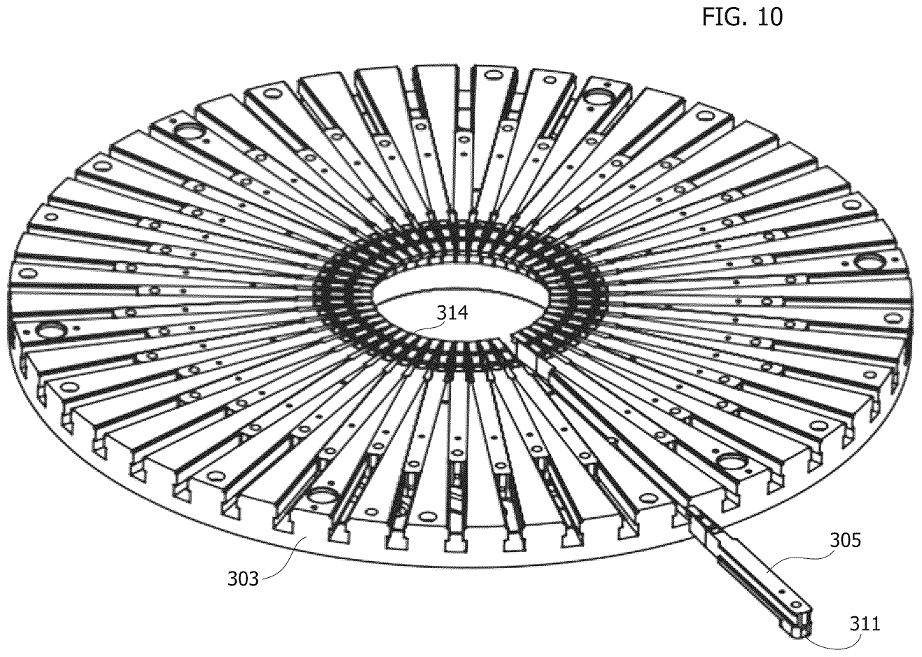

According to FIGS. 1, 3, 6, 8-10, the cutting device 300 comprises a support base 301, a first disc 302 having a plurality of equidistant spiral grooves, and a second disc 303 having a plurality of equidistant T-shaped grooves. The second disc 303 is axially arranged above the first disc 302, so the first disc 302 and the second disc 303 have a central common axis. The first disc 302 is arranged on the support base 301 and the second disc 303 is superimposed above the first disc 302, so that the first disc 302 and the second disc 303 have the central common axis, directed along a vertical direction perpendicular to the table top plate 102. The cutting device 300 further comprises a plurality of radial cam cutter assemblies arranged around the central common axis of the discs 302, 303, carried by the two discs 302, 303.

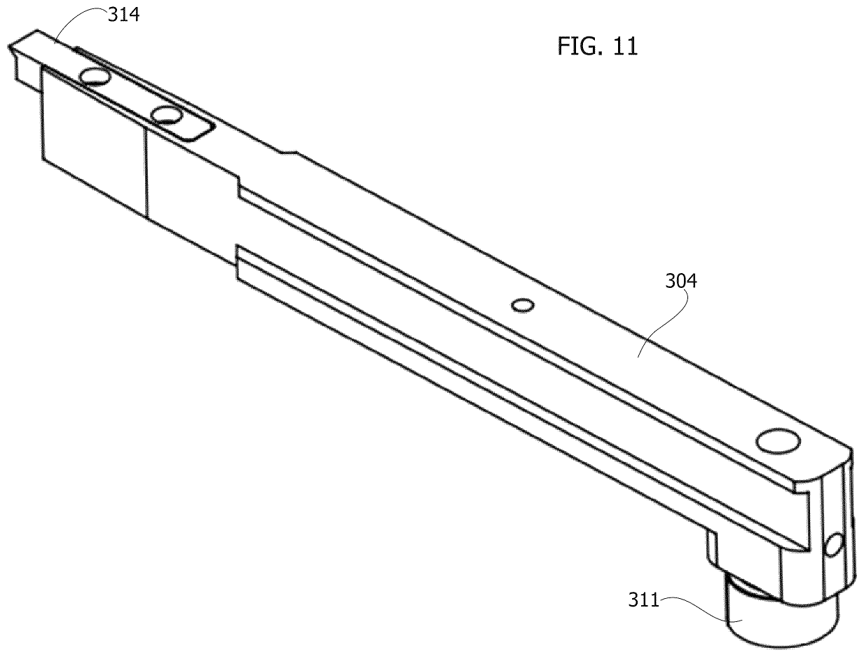

As shown in FIGS. 1, 3, 6, 8-11, each cam cutter assembly comprises a blade 314 having a cutting edge directed toward the central common axis, and a linear drive support element for supporting and driving a movement of the blade 314 along the radial direction of the discs 302, 303, towards of the central common axis and away from the central common axis. Each linear drive support element comprises a cutter holder 304, 305, and a cam 311. The cam cutter assemblies are respectively mounted into the T-shaped grooves of the second disc 303, and the cams 311 are respectively mounted into the equidistant spiral grooves. Due to this arrangement, the cutter holders and the blades are radially slidably mounted within the T-shaped grooves of the second disc 303. The spiral grooves are configured in such a way that a rotation of the first disc 302 between two end positions causes a radial movement of each cam cutter assembly between two end positions. Most preferably, the spiral groove are so configured that a rotation of the first disc 302 at a constant speed causes a radial movement of the cam cutter assemblies at a constant speed.

Accordingly, a rotation movement of the first disc 302 will cause a consequent radial movement of the blades 314.

In one or more embodiments, the blades 314 are connected to the respective cutter holder, by means of at least one removable connecting element, such as a screw, in order to avoid having to replace the entire (i.e., the entirety of the) cam cutter assembly, in case of damage of the blade.

In one or more embodiments, the cam 311 is directly fastened to the cutter holder 304, and the tail end of the cutter holder is tightened by a jackscrew to prevent loosening and falling off during the movement.

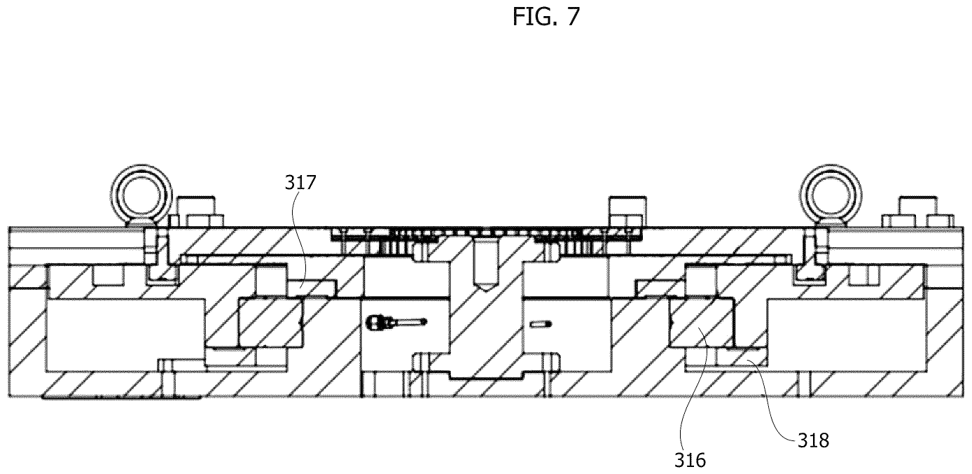

In one or more embodiments, according to FIG. 7, a lower bearing pressing ring 318, a cross roller bearing 316, and an upper bearing pressing ring 317 are arranged inside the cam cutter assembly from bottom to top.

In one or more embodiments, each spiral groove is engaged by two cams 311 carried by two adjacent cutter holders (e.g., one cam 311 for each of the cutter holders 304, 305). Therefore, the number of spiral grooves is half the number of the cam cutter assemblies. The number of the cam cutter assemblies is equal to the number of the T-shaped grooves of the second disc 303. Therefore, for a second disc 303 having 48 T-shaped grooves, 48 cam cutter assemblies are provided, while only 24 spiral grooves of the first disc 302 are provided. Due to the above indicated arrangement, the two adjacent cutter holders carrying the cams 311 which are engaged within a same spiral groove, have a different length (a long cutter holder 304 and a short cutter holder 305). In all the embodiments, the cam cutter assemblies are provided on the two discs, so that all the cutting edges result equally distanced from the common central axis of the discs 302, 303.

As previously indicated, the cutting device is driven by the at least one actuator unit. The cutting apparatus comprises at least one actuator unit for actuating the cutting device 300. According to the features of the cutting device 300 previously described, said at least one actuator unit is configured for driving in rotation the first disc 302, in order to cause a consequent simultaneous radial movement of the blades 314, for jointly cutting a plurality of wire hairpin ends protruding from an annular housing of a component for an electrical machine, in particular a stator, in order to obtain wire square flat ends protruding from the annular housing,

In one or more embodiments, the actuator unit may be at least one electric motor.

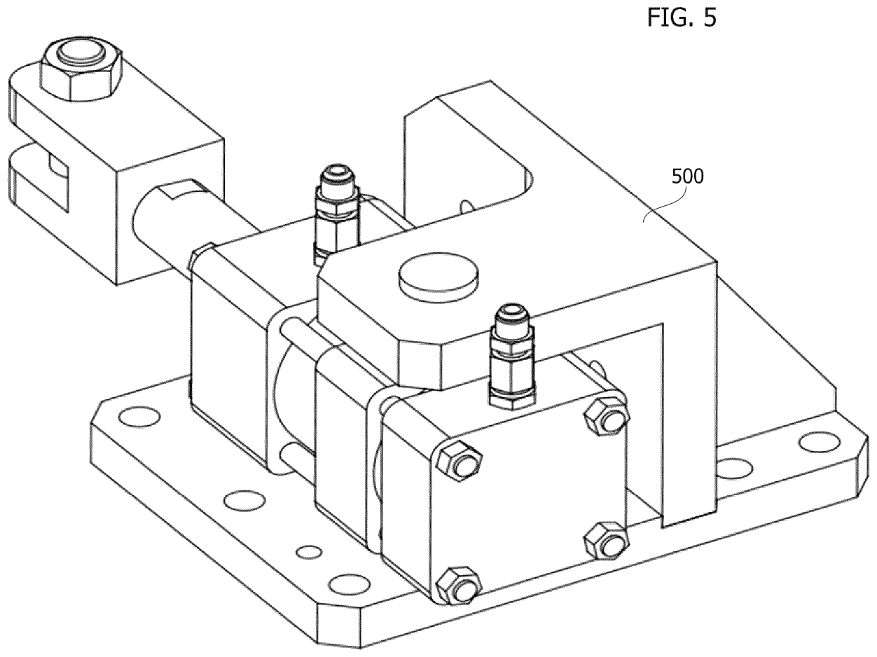

According to the embodiment shown in FIGS. 4 and 5, said at least one actuator unit may comprise a left oil cylinder structure device 400 and a right oil cylinder structure device 500 respectively arranged on two sides of the cutting device 300.

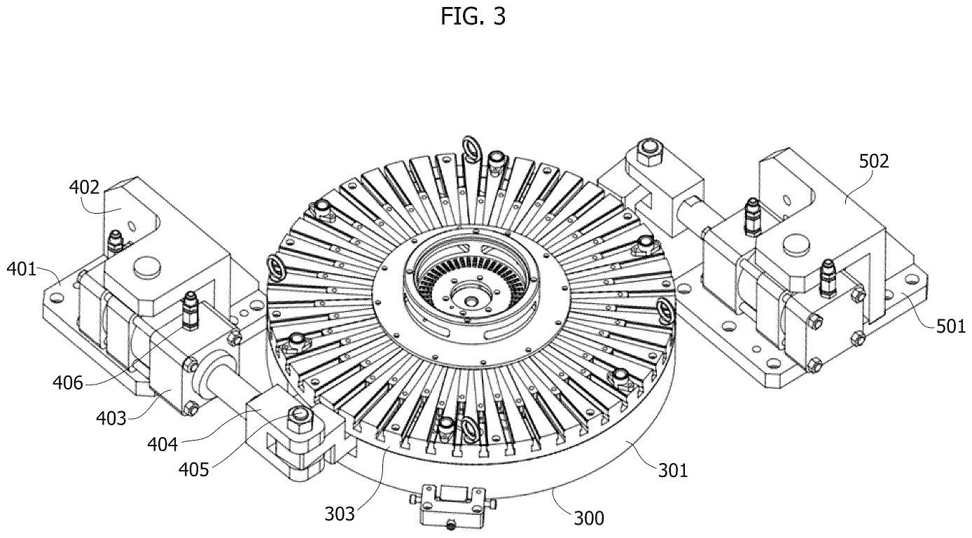

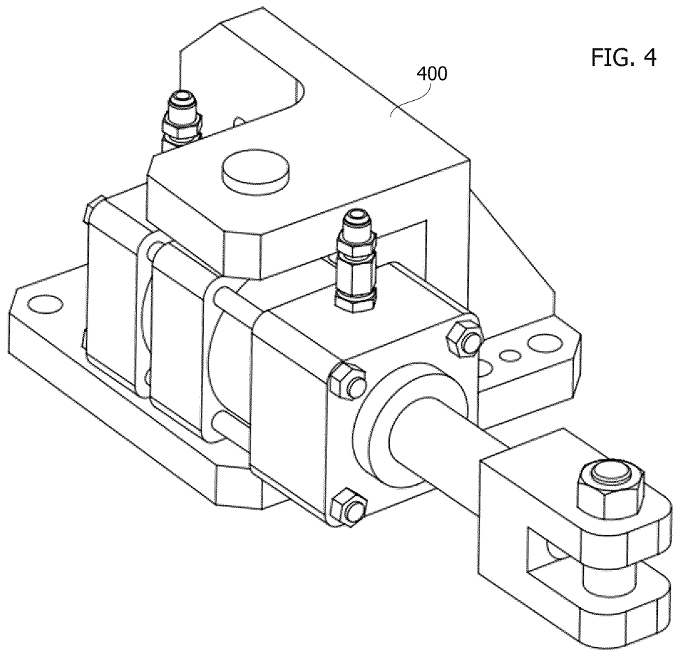

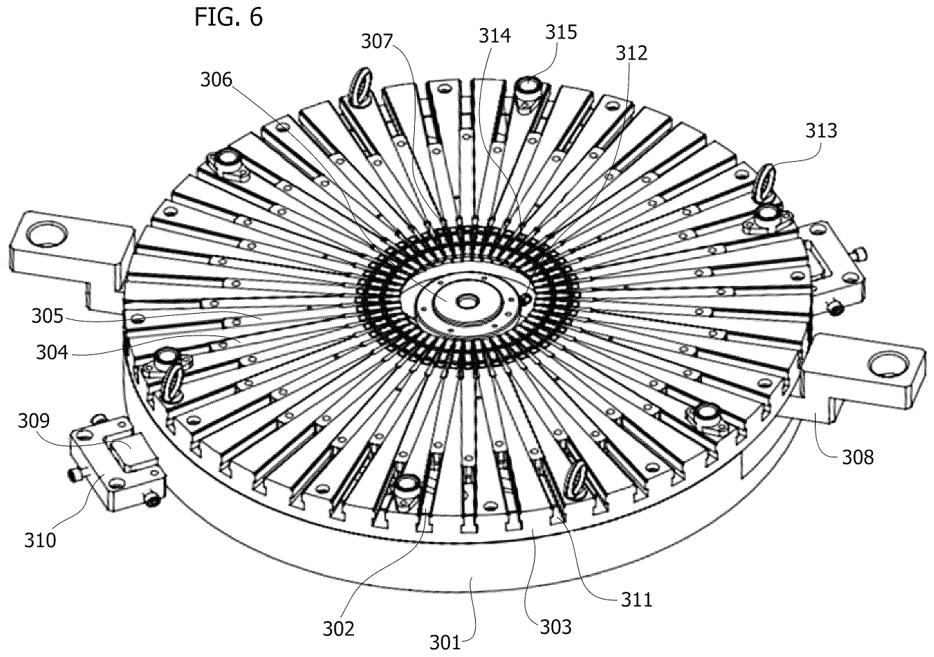

As shown in FIGS. 3 and 6, two rotary lugs 308 are connected to the outer periphery of the first disc 302. The rotary lugs 308 are respectively connected to the left oil cylinder structure device 400 and the right oil cylinder structure device 500.

In one or more embodiments, an oriented adjustment block 310 and a floating alignment block 309 are arranged on the outer periphery of the support base 301.

According to FIGS. 3-5, the left oil cylinder structure device 400 and the right oil cylinder structure device 500 are each provided with an oil cylinder fixing base plate 401 (501 for the right oil cylinder structure device 500), an oil cylinder upper fixing block 402 (502 for the right oil cylinder structure device 500) arranged on the oil cylinder fixing base plate 401, an oil cylinder 403 connecting the oil cylinder fixing base plate 401 and the oil cylinder upper fixing block 402, an oil cylinder jacking connector 404 arranged at the end of a telescopic rod of the oil cylinder 403, and a fixing shaft pin 405 connecting the oil cylinder jacking connector 404 and the rotary lug 308.

As shown in FIG. 2, the cutting apparatus may comprise a hydraulic station 112, and an oil distribution block supporting leg 107 arranged between the frame supports 101 and the hydraulic station 112. An oil distribution block 108, a hydraulic oil pipe connector 109, and an oil groove 111 are arranged at the top of the oil distribution block supporting leg 107.

During operation of one or more embodiments, oil is supplied by the hydraulic station 112 to both the left oil cylinder structure device 400 and the right oil cylinder structure device 500. The oil cylinder 403 pushes the first disc 302 to rotate so that the cam cutter assemblies uniformly slide along the T-shaped grooves of the second disc 303, synchronously and centripetally to shear the excessive copper wire to achieve the effect of flat shearing.

As previously indicated, the flat cutting apparatus comprises the robotic manipulator 600 arranged on the base frame assembly 100. The robotic manipulator 600 is configured for acting as a gripper for holding the annular housing of a component for an electrical machine, such as a stator, and moving the annular housing to an operative position for proceeding with the cutting operation of the wire ends (see FIG. 1). Therefore, the robotic manipulator 600 may displace the annular housing from a pick-up position to an operative position vertically aligned along the central axis of the cutting device.

The robotic manipulator 600 may comprise a coupling device for gripping a holding portion of the annular housing. The robotic manipulator 600 is movable along a vertical direction for raising and lowering the annular housing, and at least one horizontal direction perpendicular to the vertical direction. Therefore, the robotic manipulator 600 is configured for precisely positioning the annular housing relative to the cutting device 300.

At least one control unit is provided for controlling the robotic manipulator 600 and the cutting device 300, to carry out a precise cutting of the wire ends.

In one or more embodiments, the cutting device comprises a support flange 306 and a positioning trimming disc. The positioning support flange 306 is fitted into the support base 301 first, and then the positioning trimming disc and the positioning support flange 306 are fitted to be locked; after the assembly is completed, a check and calibration tool may be used to check whether the concentricity is within the tolerance range or not; and then the first disc 302 is rotated to check whether between the positioning trimming disc and the blades 314 is formed a gap of 0.02 mm. In addition, a cutting blade height adjustment block 307 and an oil injection nozzle 312 may be arranged at the position of a circle center. A positioning sleeve 315 and a lifting ring 313 are further arranged on a top surface of the T-shaped groove of the second disc 303.

According to FIG. 2, the cutting apparatus may comprise a waste funnel 103 arranged at the bottom of the table top plate 102, and a cutting waste pipeline 104 connected below the cutting waste funnel 103.

In one or more embodiments, after cutting the wire ends, the cut material may be wasted (e.g., transferred) by gravity through the waste funnel 103.

In one or more embodiments, the cutting apparatus may comprise a proximity sensor support 105 arranged at the middle position of the table top plate 102, and an air source fixing metal plate 106 arranged at the frame 101.

The present invention provides an efficient and fast flat cutting process, with a fast production rate, and good reliability. According to the features previously described, the expanding and retracting accuracy of the blades—along the radial direction of the discs—is extremely high, and the T-shaped grooves are used for precisely matching and sliding the cam cutter assemblies, so that the structure of the cutting device results relatively simple and compact. The cutting operation results particularly efficient and quick. Also, replacement of blades results relatively easy to perform. The present invention is compact in structure, and at the same time easy to disassemble and repair. The present invention is also flexibly applicable to robotic manipulators with gantry type mechanism.

Finally, it should be noted that the above description is only preferred embodiments of the present invention and is not intended to limit the present invention. Although the present invention is described in detail with reference to the foregoing embodiments, a person of skill in the art can still make modifications to the technical solutions described in the foregoing embodiments, or make equivalent replacements to some of the technical features, and any modifications and equivalent replacements and improvements made within the spirit and principle of the present invention shall be included within the protection scope of the present invention.

1. A cutting apparatus for jointly cutting a plurality of wire hairpin ends protruding from an annular housing of a stator, in order to obtain wire square flat ends protruding from the annular housing, wherein the cutting apparatus comprises a cutting device driven by at least one actuator unit, said cutting device comprising:
a first disc having a plurality of equidistant spiral grooves,
a second disc having a plurality of equidistant T-shaped grooves, wherein the second disc is axially arranged above the first disc, so that the first disc and the second disc have a central common axis;
a plurality of radial cam cutter assemblies carried by the first disc and the second disc, and arranged around said central common axis, wherein each radial cam cutter assembly comprises a blade having a cutting edge directed towards said central common axis, and a linear drive support element which includes a cutter holder, and a cam,
wherein the cams are respectively mounted into the equidistant spiral grooves, and the cutter holders are respectively radially slidably mounted within the equidistant T-shaped grooves,
wherein said at least one actuator unit is configured for driving in rotation the first disc, in order to cause a simultaneous radial movement of the blades for jointly cutting the plurality of wire hairpin ends protruding from the annular housing.

2. The cutting apparatus according to claim 1, wherein the blades are connected to the respective cutter holder, by at least one removable connecting element in order to avoid having to replace an entirety of the cam cutter assembly in case of damage of the blade.

3. The cutting apparatus according to claim 1, wherein each of the equidistant spiral grooves is engaged by the cam carried by each of two of the cutter holders positioned adjacent to one another.

4. The cutting apparatus according to claim 3, wherein said each of the two of the cutter holders positioned adjacent to one another have a different length, so that all the cutting edges are equally distanced from the common central axis of the first disc and the second disc.

5. The cutting apparatus according to claim 1, comprising:
a base frame assembly;
a peripheral frame assembly arranged on the base frame assembly;
a HMI interface, and
a robotic manipulator configured for acting as a gripper for holding the annular housing of the stator, and moving the annular housing to an operative position for cutting of the plurality of wire hairpin ends.

6. The cutting apparatus according to claim 1, wherein said at least one actuator unit comprises a left oil cylinder structure device and a right oil cylinder structure device respectively connected to two sides of the cutting device.

7. The cutting apparatus according to claim 1, comprising:
a waste funnel arranged below the cutting device; and
a waste pipeline connected to the waste funnel, the waste pipeline configured that, after cutting the plurality of wire hairpin ends, cut material is transferred by gravity through the waste funnel and the waste pipeline.

8. A method for jointly cutting a plurality of wire hairpin ends protruding from an annular housing of a stator, in order to obtain wire square flat ends protruding from the annular housing, the method comprising:
providing a cutting device driven by at least one actuator unit, said cutting device comprising:
a first disc having a plurality of equidistant spiral grooves;
a second disc having a plurality of equidistant T-shaped grooves, wherein the second disc is axially arranged above the first disc, so that the first disc and the second disc have a central common axis; and
a plurality of radial cam cutter assemblies carried by the first disc and the second disc, and arranged around said central common axis, wherein each radial cam cutter assembly comprises a blade having a cutting edge directed towards said central common axis, and a linear drive support element which includes a cutter holder, and a cam,
wherein the cams are respectively mounted into the equidistant spiral grooves, and the cutter holders are respectively radially slidably mounted within the equidistant T-shaped grooves; and
driving in rotation the first disc, causing a simultaneous radial movement of the blades for the jointly cutting of the plurality of wire hairpin ends protruding from the annular housing.

9. The cutting apparatus according to claim 2, wherein the at least one removable connecting element comprises a screw.
